(19) United States
(12) Patent Application Publication
(10) Pub. No.: US 2013/0124428 A1
(43) Pub. Date: May 16, 2013

(54) REFERRAL GENERATION AND PAYMENT SYSTEM AND METHOD

(71) Applicant: Christopher H. Hertz, Bethesda, MD (US)

(72) Inventor: Christopher H. Hertz, Bethesda, MD (US)

(73) Assignee: Barrel of Jobs, LLC

(21) Appl. No.: 13/296,214

(22) Filed: Nov. 14, 2011

(51) Int. Cl. G06Q 10/06

(52) U.S. Cl. 705/321

(57) ABSTRACT

A method of incentivizing distribution of job postings through social and professional networks, the method includes the steps of: associating a first identifier with a job posting, wherein the first identifier includes information further associating the first identifier with a first person; and receiving a request to associate a second identifier with the job posting, wherein the second identifier includes information associating the second identifier with a second person as well as identifying the first person as being one degree removed in an associated referral chain.

### BACKGROUND OF THE INVENTION

The present subject matter relates generally to a job referral system and method. More specifically, the present invention relates to a referral generation and payment system and method for the incentivized distribution of job postings through social and professional networks.

There are numerous employment related online career portals, job boards, associations and social and professional networks that may be used for job related interactions. For example, many websites focus on social and professional networking where a user can create a profile, upload their resume, and search for jobs and apply to them easily. Employers make use of these sites to post job requirements for a position in hopes that a well-qualified candidate will see the posting and apply to the job. Job seekers search these sites for job listings in hopes of successfully submitting their resume.

Typically, when a job opportunity is posted on an employment website, users see the posting and either apply to the job or ignore it. Sometimes, a first user might know the posting is more suitable for a second user and may pass it along to the second user. Such referrals are beneficial to both the employer and the second user that receives the job posting information from the first user. However, because there is typically no incentive to pass along the job posting, the first user who is in a position to help both the employer and the second user may not take the actions needed to make the connection or pass along the information.

The benefits of sharing job posting information can increase exponentially when such information is shared throughout personal and professional networks; however, existing systems provide little incentive to broadly share job posting information through such networks. Some systems have attempted to address this problem by providing an incentive to a referrer, but providing an incentive to a single referrer does not accomplish the goal of incentivizing distribution of the job posting through a multi-tiered network of connections.

Accordingly, a need exists for a system and method for motivating the distribution of job postings through social and professional networks as described and claimed herein.

### BRIEF SUMMARY OF THE INVENTION

The present subject matter discloses a referral generation and payment system and method adapted to motivate the distribution of job postings through social and professional networks by providing a monetary reward to be paid out to one or more people who are involved in the successful distribution of the job posting information to a hired candidate. The systems and methods provided herein may further include additional incentives and benefits, such as, an additional giveaway reward system and/or social benefits (e.g., charitable donations), as well as anti-fraud measures, such as systems and methods provided to confirm successful pairing of job posting information and candidates that leads to actual employment.

In the system and method provided herein, a job posting may be created for a job opportunity, the fulfillment of which (i.e., the hiring of a qualified candidate) results in the distribution of an associated monetary reward to selected individuals in the successful referral chain. An initial reference identifier is provided and associated with the job posting. For example, the initial reference identifier may be a website URL associated with the job posting. If a user accesses the job posting and wishes to share the posting with others, the user may generate a second reference identifier to share with the user's contacts. In this example, a second URL or other identifier may be created for the user to share. Each successive user that wishes to share the job posting may generate a unique reference identifier, the creation of which allows the system to trace and identify the path taken from the initial job posting to the eventual fulfillment of the job opening.

When the job posting requirements are filled, the monetary reward associated with the job posting is paid out to the individuals along the referral chain that led to the filling of the job posting requirements. In one example, payout may be based on the individual's position along the referral chain; the immediate referrer earning the largest portion with each subsequent referrer earning a portion based on the degree of separation between the referrer and the immediate referrer. If the referrer chain is long enough, an individual may earn nothing if the referrer is too far removed from the immediate referrer.

In some embodiments, the referral generation and payment system and method may also incorporate additional features. For example, in addition to the referral reward, some portion of the reward associated with the job posting may be donated to charity. Additionally, participation in the system and methods may qualify users for participation in a reward system through which qualified users are eligible to receive prizes in a drawing or similar manner.

Further, additional systems and methods are provided to manage the confirmation of successful pairing of candidates and job postings in order to distribute earned rewards, as well as the resolution of conflicts in which a user receives a given job posting through multiple referral chains.

Together with the leveraging of social and professional networks and the incentive to share the job information, the system and method provided herein promote users quickly pass on postings to the most relevant job candidates. This distribution of the information and the monetary reward benefits not only the employer posting the information, but the user passing on the information, and ultimately the job candidate who applies for and is chosen for the job. The system and method is particularly adapted to find qualified passive candidates, often a difficult group to reach through traditional job placement activities.

In one example, a method of incentivizing distribution of job postings through social and professional networks, the method includes the steps of: associating a first identifier with a job posting, wherein the first identifier includes information further associating the first identifier with a first person; and receiving a request to associate a second identifier with the job posting, wherein the second identifier includes information associating the second identifier with a second person as well as identifying the first person as being one degree removed in an associated referral chain. The method may further include the step of receiving a request to associate a third identifier with the job posting, wherein the third identifier includes information associating the third identifier with a third person as well as identifying the first person as being two degrees removed in the associated referral chain and the second person as being one degree removed in the associated referral chain. In addition, the method may further include the step of receiving a request to confirm the successful pairing of the job posting with a person hired to fulfill the job posting, wherein the person hired to fulfill the job posting received the job posting and an associated identifier.

Additional steps in the method may be provided, such as: confirming the successful pairing of the job posting with the person hired to fulfill the job posting; and apportioning a reward to be distributed along the referral chain leading to the successful pairing of the job posting with the person hired to fulfill the job posting, the referral chain being provided by the identifier associated with the job posting received by the person hired to fulfill the job posting. Apportioning a reward to be distributed along the referral chain leading to the successful pairing of the job posting with the person hired to fulfill the job posting may include apportioning a monetary reward across the one or more people associated with the identifier associated with the job posting received by the person hired to fulfill the job posting. Further, the apportioning of the monetary reward across one or more people may be based on the number of degrees removed each person receiving an apportionment of the monetary reward is in the associated referral chain. For example, a lesser number of degrees correlates to a higher apportionment of the monetary reward.

The method may further include the step of determining which one or more referral chains are to be used for apportioning the reward when there are two or more referral chains leading to the successful pairing of the job posting with the person hired to fulfill the job posting.

In another example, the method may further include the step of verifying the successful pairing of the job posting with the person hired to fulfill the job posting. Verifying the successful pairing of the job posting with the person hired to fulfill the job posting may include verification of the hired person's corporate email address.

The method may also include the step of apportioning a charitable donation associated with the job posting, such that successful pairing of the job posting with a person hired to fulfill the job posting triggers making the apportioned charitable donation. The size of the apportioned charitable donation may be inversely correlated to the number of identifiers associated with the job posting. Alternatively, or additionally, the size of the apportioned charitable donation may be inversely correlated to the total number of people in the referral chains associated with the identifiers.

In yet another example, the method may further include the step of crediting an account for each person associated with an identifier, such credits being used to determine participation in a reward drawing.

An example of a system of incentivizing distribution of job postings through social and professional networks includes: a controller configured to associate a first identifier with a job posting, wherein the first identifier includes information further associating the first identifier with a first person; and receive a request to associate a second identifier with the job posting, wherein the second identifier includes information associating the second identifier with a second person as well as identifying the first person as being one degree removed in an associated referral chain.

The controller may be further configured to receive a request to confirm the successful pairing of the job posting with a person hired to fulfill the job posting, wherein the person hired to fulfill the job posting received the job posting and an associated identifier.

The controller may be further configured to confirm the successful pairing of the job posting with the person hired to fulfill the job posting; and apportion a reward to be distributed along the referral chain leading to the successful pairing of the job posting with the person hired to fulfill the job posting, the referral chain being provided by the identifier associated with the job posting received by the person hired to fulfill the job posting.

The controller may be further configured to determine which one or more referral chains are to be used for apportioning the reward when there are two or more referral chains leading to the successful pairing of the job posting with the person hired to fulfill the job posting.

The controller may be further configured to verify the successful pairing of the job posting with the person hired to fulfill the job posting.

The controller may be further configured to credit an account for each person associated with an identifier, such credits being used to determine participation in a reward drawing.

An advantage of the referral generation and payment system and method is the use of unique reference identifiers, which allow the tracing of referrals that lead to the fulfillment of the requirements of the job posting.

Another advantage of the system and method is the promotion of wide distribution of job postings through social and professional networks.

A further advantage of the system and method is the monetary incentive created for users to fulfill the job posting requirements.

Yet another advantage of the system and method is the contribution to charity.

Another advantage of the system and method is the ability of job postings to reach passive candidates.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of the referral generation and payment system.

FIG. 2 illustrates the unique links that are created for and associated with different users within the referral generation and payment system and method.

FIG. 3 illustrates an example of a reward payout within the referral generation and payment system and method.

### DETAILED DESCRIPTION OF THE INVENTION

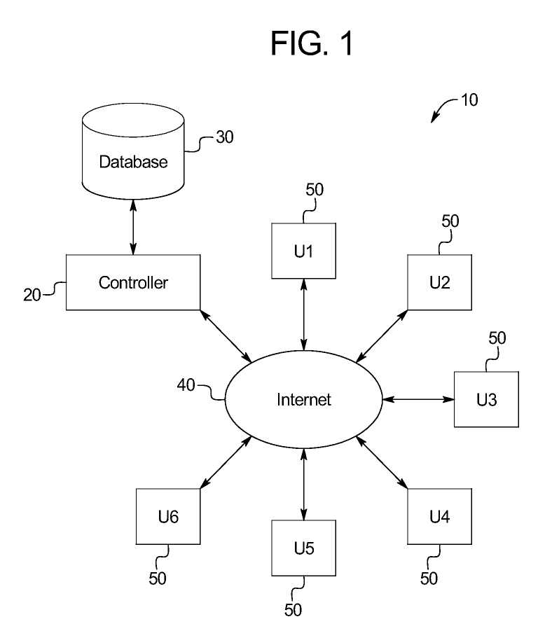

FIG. 1 illustrates an example of a referral generation and payment system 10. The referral generation and payment system 10 shown in FIG. 1 includes a controller 20 associated with a database 30. A plurality of users access and interact with the elements of the referral generation and payment system 10 via the internet 40 through a plurality of user interfaces. For example, users may access job posting information through their user interfaces 50 and through the controller 20 and database 30 generate unique reference identifiers, as described further herein. The user interfaces 50 may be any device through which the users may access the internet and/or dedicated applications. For example, the user interfaces may be computers, smartphones, or other similar devices. Generally speaking, the user interfaces 50 include one or more displays and one or more user input mechanisms, through which a user may interact with the referral generation and payment system 10. The referral generation and payment system 10 shown in FIG. 1 is particularly adapted for efficiently promoting the wide distribution of job postings to potential candidates.

Aspects of the referral generation and payment system 10 shown in FIG. 1 are controlled by the controller 20 (which may be embodied in one or more controllers 20). The controller 20 may run a variety of application programs, may access and store data, including accessing and storing data in the associated database 30 (which may be embodied in one or more databases 30) and may enable one or more interactions via the user interfaces 50. Typically, the controller 20 is implemented using one or more programmable data processing devices. The hardware elements operating systems and programming languages of such devices are conventional in nature, and it is presumed that those skilled in the art are adequately familiar therewith. Similarly, the systems and methods may be implemented on and integrated with dedicated applications, web servers, social networking platforms, etc.

For example, the controller 20 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system may also include mass storage devices such as various solid-state drives, disk drives, tape drives, etc. In operation, the main memory may store at least portions of instructions for execution by the CPU and data for processing in accord with the executed instructions.

The controller 20 may also include one or more input/output interfaces for communications with one or more processing systems. Although not shown, one or more such interfaces may enable communications via a network, e.g., to enable sending and receiving instructions electronically. The physical communication links may be wired or wireless. For example, these links may be used to communicate with the user interfaces 50.

The controller 20 may further include appropriate input/output ports for interconnection with one or more displays (e.g., monitors, printers, etc.) and one or more input mechanisms (e.g., keyboard, mouse, voice, touch, etc.) to enable an operator to use the controller 20 to provide the referral generation and payment system 10 described herein. For example, the controller 20 may include or be connected to a graphics subsystem to drive a display. The links to the peripherals may be wired or wireless connections.

Although summarized above as a PC-type and smartphone-type implementation, those skilled in the art will recognize that the description of the controller 20 also encompasses all kinds of controllers such as host computers, servers, workstations, network terminals, and the like. In fact, the use of the term controller 20 is intended to represent a broad category of components that are well known in the art.

Aspects of the referral generation and payment system 10 encompass hardware and software for controlling the relevant functions. Software may take the form of code or executable instructions for causing a controller 20 or other programmable equipment to perform the relevant steps, where the code or instructions are carried by or otherwise embodied in a medium readable by the controller 20 or other machine. Instructions or code for implementing such operations may be in the form of computer instruction in any form (e.g., source code, object code, interpreted code, etc.) stored in or carried by any readable medium.

The referral generation and payment system 10 is adapted to motivate the distribution of job postings through social and professional networks by providing a monetary reward to be paid out to one or more users who are involved in the successful distribution of the job posting information to a hired candidate.

In the referral generation and payment system 10 provided herein, a job posting may be created for a job opportunity, the fulfillment of which (i.e., the hiring of a qualified candidate) results in the distribution of an associated monetary reward to selected individuals in the successful referral chain. Information regarding the job posting is input into the system through the controller 20 and associated information is stored in the database 30. Along with the creation of the job posting, an initial reference identifier is created and associated with the job posting. Information relating to the reference identifier is also stored in the database 30. In one example, the initial reference identifier may be a website URL associated with the job posting, through which the users may access the job posting information. Alternatively, the initial reference identifier may be other unique information that may be accessed by the users and communicated to other users along with the job posting, such as, for example, a unique set of numbers and/or characters.

Users access the job posting information through their respective user interfaces 50. If a user accesses the job posting and wishes to share the posting with others, the user may generate a second unique reference identifier to share with the user's contacts. In this example, a second URL may be created for the user to share. The creation of the reference identifiers is accomplished through the controller 20 and the associated data is stored in the database 30. Each successive user that wishes to share the job posting may generate another unique reference identifier, the creation of which allows the referral generation and payment system 10 to trace and identify the path taken from the initial job posting to the eventual fulfillment of the job opening.

When the job posting requirements are filled, the monetary reward associated with the job posting is paid out to the individuals along the referral chain that led to the filling of the job posting requirements. Payout is based on the individual's position along the referral chain; the immediate referrer earning the largest portion with each subsequent referrer earning a portion based on the degree of separation between the referrer and the immediate referrer. If the referrer chain is long enough, an individual may earn nothing if the referrer is too far removed from the immediate referrer.

In some embodiments of the referral generation and payment system 10, in addition to the referral reward, some portion of the reward associated with the job posting may be donated to charity.

As demonstrated, due to the financial incentive to share the job information, referral generation and payment system 10 promotes users to quickly pass on job postings to the most relevant job candidates. This distribution of the information and the monetary reward benefits not only the employer posting the information, but the user passing on the information, and ultimately the job candidate who applies for and is chosen for the job. Due to the leveraging of social and professional networks, the referral generation and payment system 10 is particularly adapted to find qualified passive candidates, often a difficult group to reach through traditional job placement activities.

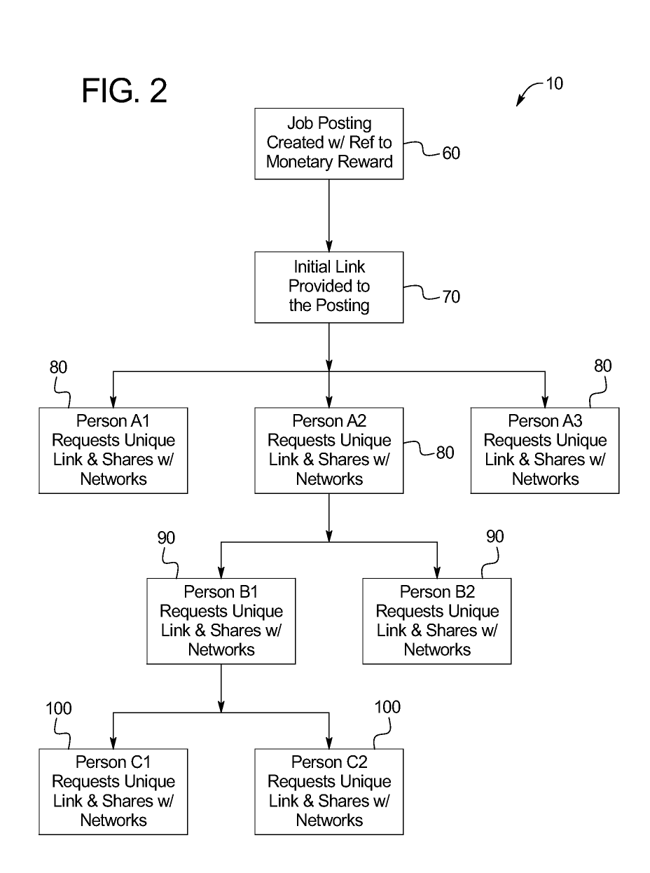

Turning now to FIG. 2, an example of a method of using the referral generation and payment system 10 is shown. As shown in FIG. 2, in a first step 60 a job posting is created, for which a monetary reward for the fulfillment of the job requirements is associated. As shown in the second step 70 shown in FIG. 2, an initial reference identifier is created and associated with the job posting information. For example, the initial reference identifier may be a unique URL through which users may access the job posting information. As described above with reference to FIG. 1, the job posting and unique reference identifier may be created in the referral generation and payment system 10 through the controller 20 and associated information may be stored in the database 30. The job posting information is then made available to users to access and share.

As further shown in FIG. 2, once the job posting information is available to users, a first set of users may directly access the job posting information. It is contemplated that the job posting information may be automatically distributed to users who have set up custom queries or alerts. Additionally, in some embodiments, the job posting information may be automatically distributed through users' networks based on customizable configuration controls. For example, a user may set up an account within the system 10 through which the user may subscribe to job posting information (or defined subsets of job posting information) and may further define parameters through which the subscribed job posting information may be shared with specified distribution lists/networks. For example, a user may configure an account to receive job posting information within certain geographic, subject matter, pay scale, etc. parameters and may further configure how one or more sets and/or subsets of such subscribed job postings may be automatically shared with others in the users network. In one example, a user may subscribe to local engineering positions offering salary above a defined threshold and may further chose to automatically forward a subset of the subscribed postings to other individuals. For example, one subset may receive electrical engineering postings, another subset may receive mechanical engineering postings, etc.

As shown in FIG. 2, the direct access users 80 (i.e., the first tier of users 80) may each interact with the referral generation and payment system 10 to create unique reference identifiers to then be shared with a second tier of users 90 referred to the job posting information by the first tier of users 80, whether by direct email, sharing over social media networks, etc. Similarly, the second tier of users 90 may create their own unique reference identifiers to be shared with a third tier of users 100. Accordingly, the example shown in FIG. 2 illustrates how a job posting may be shared through three tiers of referrals and how the path to each user may be traced due to the use of unique reference identifiers, such as, for example, unique URLs created for each user wherein each URL is associated with data regarding the referral path. The data being stored in the database 30.

The referral pattern shown in FIG. 2 is merely one possible example shown for illustrative purposes. It is expected that in many instances, the referral pattern for a given job posting may be significantly more complex and tortuous.

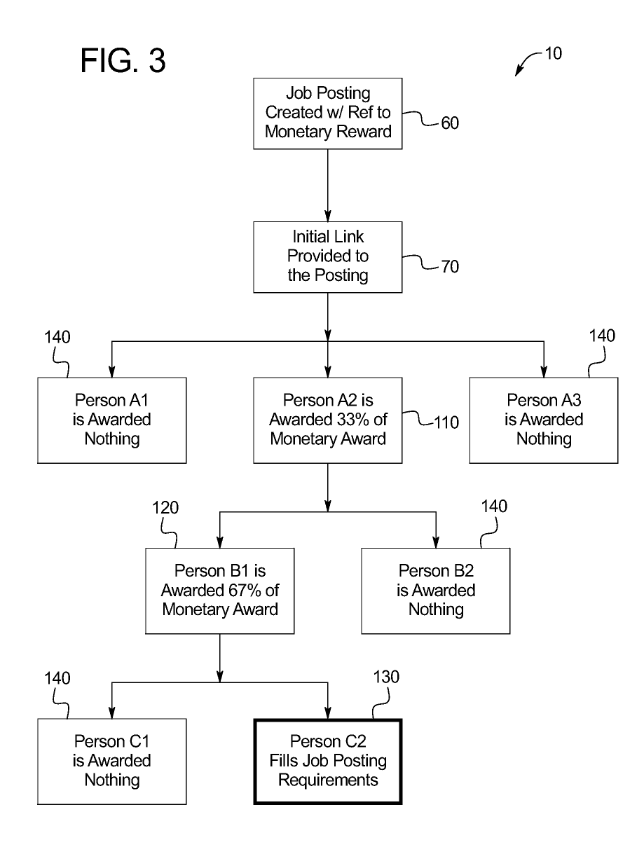

Referring now to FIG. 3, the three tiers of referrals shown in FIG. 2 are recreated, this time illustrating that a user in the third tier of users 100 is the candidate that fulfilled the job requirements of the job posting. FIG. 3 illustrates one example of how the monetary reward associated with the job posting may be distributed amongst the users in the referral path.

As shown in FIG. 3, when the job posting requirements are filled, the monetary reward associated with the job posting are paid out to the individuals along the referral chain that led to the filling of the job posting requirements. Payout is based on the individual's position along the referral chain. In FIG. 3, the person that fulfilled the job requirements is shown as the hired user 130. As shown, the immediate referrer 120 (i.e., one degree of separation from the hired user 130) earns the largest portion of the reward. For each subsequent degree of separation from the hired user 130 a user is, the smaller the percentage of the reward is earned by the user.

In the example provided in FIG. 3, the immediate referrer 120 earns 67% of the associated reward. The user with two degrees of separation from the hired user 130 receives the second highest percentage of the reward; in this example 33% of the associated reward. Because there are no other users along the referral path shown in FIG. 3, there is no other division of the monetary reward. The users that are not a part of the successful referral chain (i.e., the remaining users 140) do not receive any amount of monetary reward.

Although there are specific percentages of the reward provided in the example given with reference to FIG. 3, it is contemplated that in other embodiments the distribution may be varied to provide the level of incentives desired in the execution of the referral generation and payment system 10.

In addition to the monetary reward, it is contemplated that the system 10 and method may be adapted to further make charitable contributions. For example, in order to create a job posting within the system 10, an employer may provide a required fee. That fee may be used to fund the monetary reward described above with respect to FIG. 3, as well to fund charitable contributions. The size of the charitable donation may be dependent on the amount of participation in sharing the job posting. For example, as the job posting is shared with a greater number of potential candidates, the size of the pot designated as a charitable donation may increase. Alternatively, the size of the charitable donation may increase based on the times it is shared rather than the number of people with whom it is shared. Of course other metrics used to evaluate the quality and quantity of sharing may be used to determine the size of the charitable donation.

Additionally, it is contemplated that further incentives may be created to participate in the system 10 provided herein. It is believed that one of the most important aspects to realizing the benefits of the system 10 is the broad sharing through social and professional networks. Thus, incentivizing the sharing aspect, in addition to rewarding individual successes, may play a critical role in the success of the system 10. To that end, it is contemplated that in some embodiments of the system 10 users may be rewarded for their participation, regardless of success, through a reward system through which qualified users are eligible to receive prizes in a drawing or similar manner. For example, users may earn credits for sharing job posting information, such credits are used to qualify the user for opportunities in a drawing, and periodic drawings may then be made to reward participating users, regardless of whether or not the rewarded users have successfully paired applicants and employers.

It is further contemplated that the system 10 and methods provided herein may be improved by providing methods for conflict resolution between various shared referral paths as well as methods of confirming whether a successful pairing of applicant and employer has been made, leading to employment of the applicant and, as a result, the payment of the monetary reward through the referral network.

In a first example, “User E” receives a job posting through two distinct referral chains. Chain 1 originates with User A through User B through User C through User D to User E. Chain 2 originates with User Z through User X through User Y to User E. As shown, User E has now received the job posting through two distinct referral chains. User E can then forward none, one or both referrals. Assuming User E forwards the job posting from referral Chain 2 to User N, who applies, interviews, and gets the job from the shared job posting, the monetary reward is paid out along the referral path of Chain 2. Alternatively, User E may forward both chains to User N and User N may use the referral from Chain 1 to apply, interview, and get the job. In such case, the monetary reward is paid out along the referral path of Chain 1. In another alternative example, User E may forward both chains to User N and User N may first view the job posting forward from Chain 1, then view it from Chain 2, then use the referral from Chain 1 to apply, interview, and get the job. In such case, the monetary reward is paid out along the referral path of Chain 1, because that was the referral path selected for the job application.

It is further contemplated that confirmation/validation of successful pairing of an applicant (and referral chain) with a job posting that leads to employment may be difficult as the employer may not be willing to share such information with the system 10. In such instances, creative methods of confirmation may be employed. In one example, in order to confirm employment, a referring user (or the employed user) may provide the system 10 the employed user's email address at the new position corresponding to the job posting. The system 10 may then send a confirmation email to the provided email address to which the employed user may respond to verify the employment. This verification method relies on the email address as confirmation of the employment. It is understood that other confirmation methods may be employed.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method of incentivizing distribution of job postings through social and professional networks, the method comprising the steps of:
associating a first identifier with a job posting, wherein the first identifier includes information further associating the first identifier with a first person; and
receiving a request to associate a second identifier with the job posting, wherein the second identifier includes information associating the second identifier with a second person as well as identifying the first person as being one degree removed in an associated referral chain.

2. The method of claim 1 further comprising the step of receiving a request to associate a third identifier with the job posting, wherein the third identifier includes information associating the third identifier with a third person as well as identifying the first person as being two degrees removed in the associated referral chain and the second person as being one degree removed in the associated referral chain.

3. The method of claim 1 further comprising the step of receiving a request to confirm the successful pairing of the job posting with a person hired to fulfill the job posting, wherein the person hired to fulfill the job posting received the job posting and an associated identifier.

4. The method of claim 3 further comprising the steps of:
confirming the successful pairing of the job posting with the person hired to fulfill the job posting; and
apportioning a reward to be distributed along the referral chain leading to the successful pairing of the job posting with the person hired to fulfill the job posting, the referral chain being provided by the identifier associated with the job posting received by the person hired to fulfill the job posting.

5. The method of claim 4 wherein the step of apportioning a reward to be distributed along the referral chain leading to the successful pairing of the job posting with the person hired to fulfill the job posting includes apportioning a monetary reward across the one or more people associated with the identifier associated with the job posting received by the person hired to fulfill the job posting.

6. The method of claim 5 wherein the apportioning of the monetary reward across one or more people is based on the number of degrees removed each person receiving an apportionment of the monetary reward is in the associated referral chain.

7. The method of claim 6 wherein a lesser number of degrees correlates to a higher apportionment of the monetary reward.

8. The method of claim 4 further comprising the step of determining which one or more referral chains are to be used for apportioning the reward when there are two or more referral chains leading to the successful pairing of the job posting with the person hired to fulfill the job posting.

9. The method of claim 4 further comprising the step of verifying the successful pairing of the job posting with the person hired to fulfill the job posting.

10. The method of claim 9 wherein the step of verifying the successful pairing of the job posting with the person hired to fulfill the job posting includes verification of the hired person's email address.

11. The method of claim 1 further comprising the step of apportioning a charitable donation associated with the job posting, such that successful pairing of the job posting with a person hired to fulfill the job posting triggers making the apportioned charitable donation.

12. The method of claim 11 wherein the size of the apportioned charitable donation correlates to the number of identifiers associated with the job posting.

13. The method of claim 11 wherein the size of the apportioned charitable donation correlates to the total number of people in the referral chains associated with the identifiers.

14. The method of claim 1 further including the step of crediting an account for each person associated with an identifier, such credits being used to determine participation in a reward drawing.

15. A system of incentivizing distribution of job postings through social and professional networks, the system comprising:
a controller configured to associate a first identifier with a job posting, wherein the first identifier includes information further associating the first identifier with a first person;
and receive a request to associate a second identifier with the job posting, wherein the second identifier includes information associating the second identifier with a second person as well as identifying the first person as being one degree removed in an associated referral chain.

16. The system of claim 15 wherein the controller is further configured to receive a request to confirm the successful pairing of the job posting with a person hired to fulfill the job posting, wherein the person hired to fulfill the job posting received the job posting and an associated identifier.

17. The system of claim 16 wherein the controller is further configured to confirm the successful pairing of the job posting with the person hired to fulfill the job posting; and apportion a reward to be distributed along the referral chain leading to the successful pairing of the job posting with the person hired to fulfill the job posting, the referral chain being provided by the identifier associated with the job posting received by the person hired to fulfill the job posting.

18. The system of claim 17 wherein the controller is further configured to determine which one or more referral chains are to be used for apportioning the reward when there are two or more referral chains leading to the successful pairing of the job posting with the person hired to fulfill the job posting.

19. The system of claim 18 wherein the controller is further configured to verify the successful pairing of the job posting with the person hired to fulfill the job posting.

20. The system of claim 19 wherein the controller is further configured to credit an account for each person associated with an identifier, such credits being used to determine participation in a reward drawing.
